(19) United States
(12) Patent Application Publication
(10) Pub. No.: US 2008/0156046 A1
(43) Pub. Date: Jul. 3, 2008

(54) Multifunctional padlock having shackle limit knob

(76) Inventor: Chun Te Yu, Fusing Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/073,912

(22) Filed: Mar. 12, 2008

Related U.S. Application Data
(63) Continuation of application No. 11/474,936, filed on Jun. 27, 2006, now Pat. No. 7,370,497.
Application No. 11/474,936 is a continuation-in-part of application No. 11/032,116, filed on Jan. 11, 2005, now Pat. No. 7,100,401.

(51) Int. Cl. E05B 37/02

(52) U.S. Cl. 70/21

(57) ABSTRACT

A padlock includes a housing, a shackle, a limit knob, a movable member and a locking mechanism. The shackle is movably mounted on the housing and includes a root section disposed within the housing and a free section which extends from the root section and is disposed outside of the housing. The limit knob is movably mounted on the housing to control movement of the free section of the shackle. The movable member is movably disposed at the limit knob. In addition, the locking mechanism includes a key lock unit disposed in the housing and a movable unit movably disposed in the housing. The key lock unit is configured to control movement of the limit knob and defines a key hole to receive a key. The movable unit includes a first portion engaged with the movable member and a second portion received in and aligned with the key hole of the key lock unit so that when the key is inserted into the key hole to actuate the movable unit, the movable member is driven by the movable unit to move from its original position to an indicative position which is at the limit knob.

### CROSS REFERENCE TO RELATED APPLICATION

This is a continuation application of co-pending U.S. patent application Ser. No. 11/474,936, filed on Jun. 27, 2006, which is a continuation-in-part of U.S. Pat. No. 7,100,401, filed on Jan. 11, 2005, and also a continuation-in-part of U.S. Publication No. 2006-0107708 A1, filed on Nov. 15, 2005.

### BACKGROUND OF THE INVENTION

1. Field of the Invention

The present invention relates to a padlock, and more particularly to a multifunctional padlock having an outwardly exposed shackle limit knob.

2. Description of the Related Art

A conventional padlock disclosed in U.S. Pat. No. 6,860,125 and U.S. Publication No. 2005/0034492 comprises a locking mechanism, a shackle, and a shackle limit knob. The shackle limit knob is controlled by the locking mechanism to lock or release the free end of the shackle.

Another conventional padlock disclosed in the U.S. Pat. No. 6,848,283 and the U.S. Publication Nos. 2002/0088256, 2004/0226323, 2004/0226324 and 2005/0039500 has a double lock function to facilitate the inspector of the customs checking the luggage.

Another conventional padlock disclosed in the U.S. Pat. Nos. 6,877,345 and 7,007,521 has a double lock function and has an indicator to remind if the padlock has been opened by a key. Such a padlock does not have a shackle limit knob.

Another conventional padlock disclosed in the U.S. Publication No. 2005/0262902 has a double lock function and has an indicator and a shackle to remind if the padlock has been opened by a key. The indicator cannot indicate if the padlock has been opened by an insert instead of a key.

### SUMMARY OF THE INVENTION

The present invention is to mitigate and/or obviate the disadvantage of the conventional padlock.

The primary objective of the present invention is to provide a padlock, wherein when the key or an insert is inserted into the key hole, the extension of the movable member is detached from the peep hole of the limit knob to remind the user that the first locking mechanism has been operated and opened by an external force, so that the user can open the luggage by unlocking the padlock to check if the items contained in the luggage are missed.

Another objective of the present invention is to provide a padlock, wherein the extension of the movable member functions as an indicator that is directly mounted on the limit knob without occupy the inner space of the housing, so that the padlock has a smaller volume.

A further objective of the present invention is to provide a padlock, wherein the indicator is directly mounted on the limit knob, so that the padlock has an excellent reminding effect.

In accordance with the present invention, there is provided a padlock, comprising a housing, a shackle, a limit knob, a movable member and a locking mechanism. The shackle is movably mounted on the housing and includes a root section disposed within the housing and a free section which extends from the root section and is disposed outside of the housing. The limit knob is movably mounted on the housing to control movement of the free section of the shackle. The movable member is movably disposed at the limit knob. In addition, the locking mechanism includes a key lock unit disposed in the housing and a movable unit movably disposed in the housing. The key lock unit is configured to control movement of the limit knob and defines a key hole to receive a key. The movable unit includes a first portion engaged with the movable member and a second portion received in and aligned with the key hole of the key lock unit so that when the key is inserted into the key hole to actuate the movable unit, the movable member is driven by the movable unit to move from its original position to an indicative position which is at the limit knob.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a padlock in accordance with an embodiment of the present invention;

FIG. 2 is a schematic operational view of the padlock as shown in FIG. 1;

FIG. 3 is a partially exploded perspective view of the padlock as shown in FIG. 1;

FIG. 4 is a plan cross-sectional view of the padlock as shown in FIG. 1;

FIG. 5 is a schematic operational view of the padlock as shown in FIG. 4;

FIG. 6 is a perspective assembly view as shown in FIG. 3;

FIG. 7 is a schematic operational view as shown in FIG. 6;

FIG. 8 is a plan cross-sectional view taken along line 8-8 as shown in FIG. 4;

FIG. 9 is a schematic operational view as shown in FIG. 8;

FIG. 10 is a partially exploded perspective view of another embodiment of the present invention;

FIG. 11 is a top plan view as shown in FIG. 10; and

FIG. 12 is a schematic operational view as shown in FIG. 11.

### DETAILED DESCRIPTION OF THE INVENTION

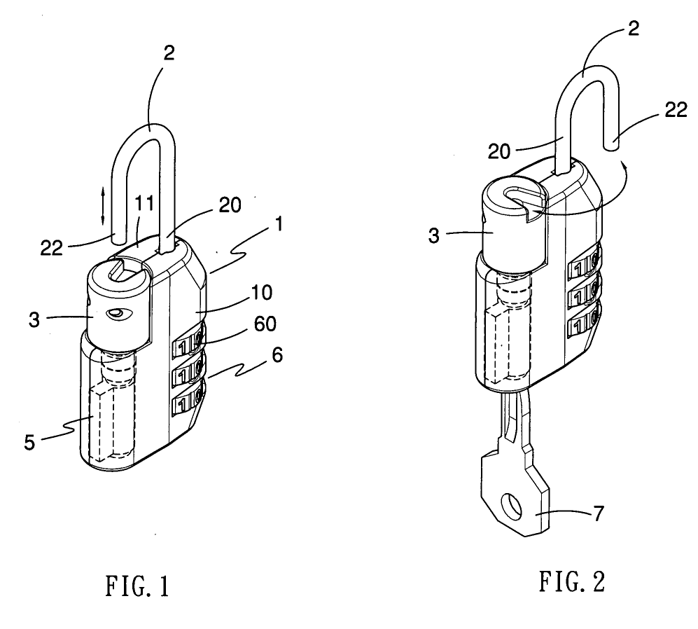

Referring to the drawings and initially to FIGS. 1-9, a padlock for a luggage in accordance with the preferred embodiment of the present invention comprises a housing 1, a shackle 2, a limit knob 3, a movable member 4, a first locking mechanism 5, and a second locking mechanism 6.

The housing 1 consists of two shells 10 and 11. The shackle 2 is movably mounted on the housing 1 and includes a root section 20 extending into the housing 1 to form a movable connection with the housing 1, and a free section 22 having a first end extending from the root section 20 and a second end extending into the limit knob 3. The limit knob 3 is movably mounted on the housing 1 to control movement of the free section 22 of the shackle 2. The limit knob 3 includes a knob body 30, a limit plate 33, a shaft portion 34 and a base portion 32 extending from an end of the shaft portion 34. The knob body 30 is rotatably mounted on the housing 1 via the base portion 32. The limit plate 33 is secured in the housing 1 and connected with the knob body 30 to confine the knob body 30 to the housing 1. The shaft portion 34 extends from an interior of the knob body 30. The base portion 32 is received in the housing 1.

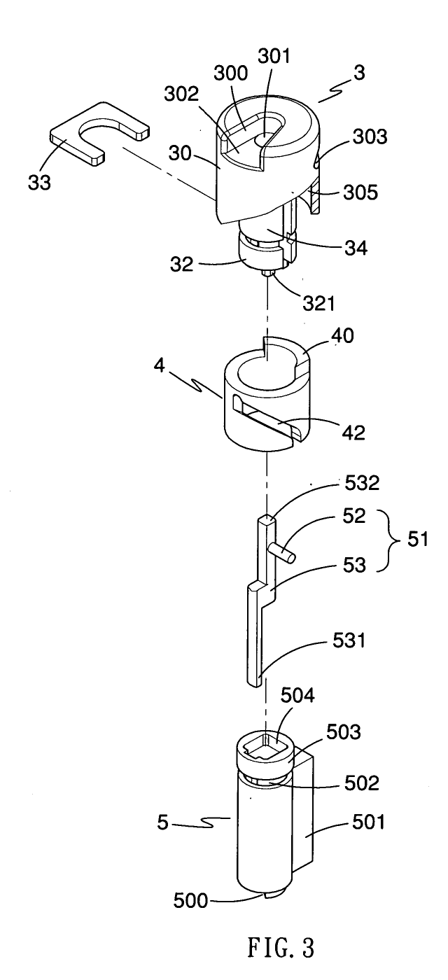

As shown in FIGS. 3 and 4, the movable member 4 is annular-shaped and movably mounted about the shaft portion 34 of the limit knob 3. The first locking mechanism 5 disposed in the housing 1 is configured to directly control movement of the limit knob 3 and the movable member 4.

In this embodiment, the first locking mechanism 5 includes a key lock unit 50 and a movable unit 51, namely a movable shaft 51. The key lock unit 50 defines a key hole 500 in an end to receive a matching key 7. The movable unit or shaft 51 is partially, movably received in the key hole 500 or the key lock unit 50. As shown in FIGS. 3 and 4, the movable includes a stick 53 and a guide rod 52 transversely extending from a side of the stick 53. The stick 53 of the movable shaft 51 has a lower end 531 received in and aligned with the key hole 500 of the key lock unit 50 and an upper end 532 pointing at the trapped free section 22 of the shackle 2 as shown in FIG. 4. The guide rod 52 of the movable shaft 51 is engaged with the movable member 4, which will be discussed in detail hereinafter. In such a fashion, when the key 7 or an insert (not shown) is inserted into the key hole 500 of the key lock unit 50 to a predetermined position, the movable shaft 51, including the stick 53 and the guide rod 52, is pushed by the key 7 or the insert in a direction, which in turn drives the movable member 4 to move. It is therefore that the first locking mechanism 5 directly controls movement of the movable member 4 via the movable unit or shaft 51.

The key lock unit 50 includes a lock core 501 secured in the housing 1, and a mandrel 502 received in the lock core 501 and being capable of being driven and rotated by the key 7. The mandrel 502 has one end formed with a control portion 503 engaged with the base portion 32 of the limit knob 3. Specifically, the control portion 503 of the mandrel 502 has an upper end formed with a square recess 504, and the base portion 32 of the limit knob 3 has a lower end formed with a square plug 321 received in the square recess 504 of the mandrel 502 so that the limit knob 3 can be directly driven and rotated by the key lock unit 50 of the first locking mechanism 5.

The second locking mechanism 6 including a number lock module 60 is mounted on the housing 1 to control upward and downward movement of the root section 20 of the shackle 2. The number lock module 60 is engaged with the root section 20 of the shackle 2 and is configured to control movement of the root section 20 of the shackle 2.

Thus, as shown in FIG. 1, when the number lock module 60 is disposed at an unlocked state (when the code is correct), the root section 20 of the shackle 2 is released and allowed to be detached from the limit knob 3 by pulling the shackle 2 in a direction away from the housing 1. Alternatively, as shown in FIG. 2, when the number lock module 60 is disposed at a locked state (when the code is incorrect), the root section 20 of the shackle 2 is locked. At this time, the limit knob 3 can be driven and rotated by operating the key lock unit 50 of the first locking mechanism 5 to expose the free section 22 of the shackle 2 outside. After that, the free section 22 of the shackle 2 can be rotated about the root section 20 of the shackle 2 to detach from the limit knob 3.

Referring to FIG. 3, the knob body 30 of the limit knob 3 has an outer portion formed with a receiving recess 300 to receive the free section 22 of the shackle 2 and an inner portion formed with a receiving chamber 305 to receive the movable member 4. The receiving recess 300 has a central portion formed with a first opening 301 and a peripheral wall formed with a second opening 302 in communication with the first opening 301 so that the free section 22 of the shackle 2 may be detached from the limit knob 3 through either the first opening 301 vertically or the second opening 302 horizontally. That is, the first opening 301 enables the free section 22 of the shackle 2 to move in or out of the knob body 30 of the limit knob 3 vertically, and the second opening 302 enables the free section 22 to rotate in or out of the knob body 30 about the root section 20 of the shackle 2 horizontally.

Furthermore, the knob body 30 of the limit knob 3 has a side wall formed with a peep hole 303. While the movable member 4 is in a first position, an extension 40 of the movable member 4 is exposed in the peep hole 303 of the limit knob 3. However, when the key 7 or an insert is inserted into the key hole 500 of the key lock unit 50 to touch the lower end 531 of the stick 53, the movable shaft 51 is driven to move the movable member 4 from the first position to a second position where the extension 40 of the movable member 4 is detached from the peep hole 303 of the limit knob 3. It is therefore that the extension 40 of the movable member 4 disappears from the peep hole 303 of the limit knob 3 as a result of the insertion of the key 7 or the insert, which indicates that the first locking mechanism 5 has been operated or tampered with.

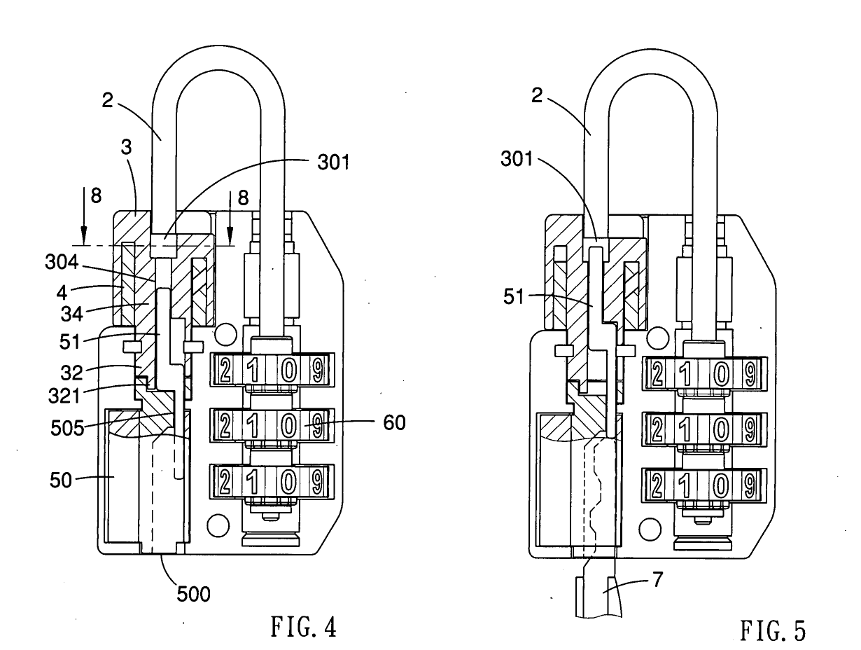

As shown in FIG. 4, the limit knob 3 has an inside formed with a through hole 304 passing through the shaft portion 34 and the base portion 32 of the limit knob 3. The through hole 304 is in communication with the first opening 301 of the limit knob 3 and the square recess 504 of the mandrel 502 of the key lock unit 50. The upper end 532 of the stick 53 of the movable shaft 51 is movably received in and aligned with the through hole 304. The mandrel 502 of the key lock unit 50 of the first locking mechanism 5 has an inner portion formed with a through bore 505 in communication with the square recess 504 of the mandrel 502 and the key hole 500 of the key lock unit 50. Thus, the movable shaft 51 of the first locking mechanism 5 is movable in a passage defined between the key hole 500, the through bore 505, the square recess 504, the through hole 304 and the first opening 301. In addition, when the key 7 or an insert is inserted into the key hole 500 of the key lock unit 50, the movable shaft 51 of the first locking mechanism 5 is moved upward to a determined position where the upper end 532 of the stick 53 is exposed in a lower position of the first opening 301 of the limit knob 3, as shown in FIG. 5.

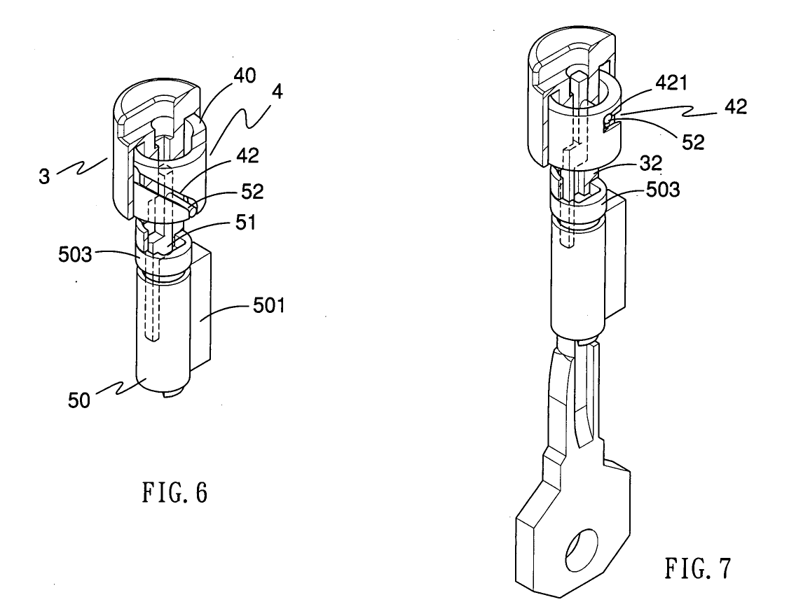

As shown in FIG. 6, the movable member 4 has a peripheral formed with a helical guide groove 42, and the guide rod 52 of the movable shaft 51 is movably received in the guide groove 42 of the movable member 4 and engaged with the movable member 4. Thus, when the movable shaft 51 of the first locking mechanism 5 is moved upward to the determined position as shown in FIG. 5 where the upper end 532 of the stick 53 is exposed in the first opening 301 of the limit knob 3, the guide rod 52 of the movable shaft 51 is lifted through the guide groove 42 of the movable member 4 to drive the movable member 4 to rotate with respect to the limit knob 3.

As shown in FIG. 7, the guide groove 42 of the movable member 4 has a top end formed with a positioning cavity 421 to position the guide rod 52 of the movable shaft 51 when the guide rod 52 of the movable shaft 51 is lifted to the top end of the guide groove 42 of the movable member 4 so as to prevent the movable shaft 51 from being moved freely due to the gravity or an external force.

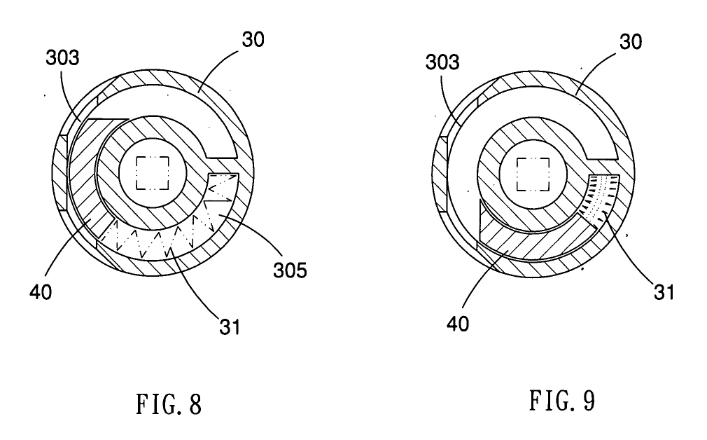

As shown in FIG. 8, the limit knob 3 further includes an elastic member 31 received in the receiving chamber 305 of the knob body 30 and biased between the knob body 30 and the extension 40 of the movable member 4. When the movable member 4 is moved from the first position where the extension 40 is exposed in the peep hole 303 of the limit knob 3 to the second position where the extension 40 is detached from the peep hole 303 of the limit knob 3, the guide rod 52 of the movable shaft 51 is positioned in the positioning cavity 421 of the guide groove 42 of the movable member 4 as shown in FIG. 7, and the elastic member 31 is compressed by the extension 40 of the movable member 4 as shown in FIG. 9. It is therefore that the extension 40 of the movable member 4 departs from the peep hole 303 of the limit knob 3, which reminds the user that the first locking mechanism 5 has been operated or tampered with.

In order to return the movable member 4 from the second position back to the first position, the free section 22 of the shackle 2 or an inert can be applied as long as the lock module 60 is disposed at an unlocked state (when the code is correct). For example, the free section 22 of the shackle 2 may be inserted into the lower position of the first opening 301 of the limit knob 3 to push the upper end 532 of the movable shaft 51 downward. At this time, the guide rod 52 of the movable shaft 51 is detached from the positioning cavity 421 of the guide groove 42 and moves downward, and the elastic member 3 is released. While the movable shaft 51 goes down, the elastic member 31 drives the movable member 4 to rotate in the opposite direction due to the restoring force thereof. Hence the first opening 301 which is in communication with the through hole 304 can be inserted by the free section 22 of the shackle 2 or the insert so as to return the movable member 4 from the second position back to the first position. In other words, the movable unit or shaft 51 can be directly driven by the free section 22 of the shackle 2 or the insert to move the movable member 4 back to the original or first position. Also, the extension 40 of the movable member 4 is allowed to be returned back to its original position and exposed in the peep hole 303 of the limit knob 3 only if the number lock module 60 is disposed at an unlocked state (when the code is correct).

Accordingly, when the key 7 or an insert is inserted into the key hole 500, the extension 40 of the movable member 4 departs from the peep hole 303 of the limit knob 3 to remind the user that the first locking mechanism 5 has been operated or tampered with. The user may unlock the padlock and open the luggage to check if the goods contained in the luggage are missed. Since the extension 40 of the movable member 4 served as an indicator is directly mounted on the limit knob 3 without occupy the inner space of the housing 1, the padlock has a smaller volume. Further, because the movable member 4 or the indicator is directly mounted on the limit knob 3 which is outside of the housing 1, the padlock has an excellent reminding effect.

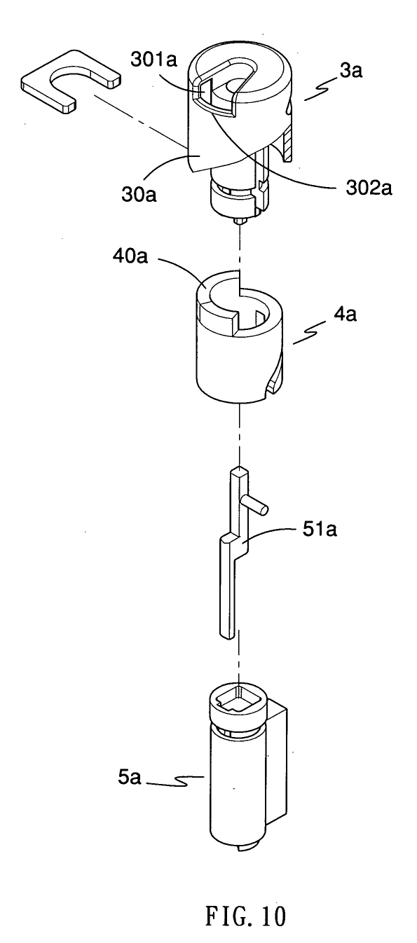

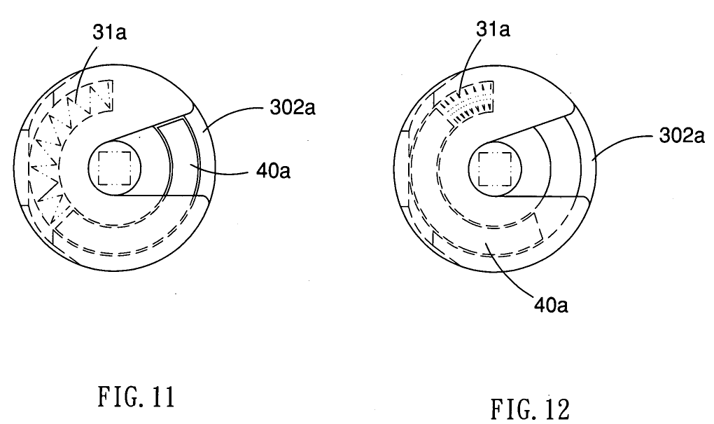

Similar to the above embodiment, FIGS. 10-12 further show a structure of a limit knob 3a, a movable member 4a and a first locking mechanism 5a, as another embodiment of the present invention. In this embodiment, the extension 40a of the movable member 4a is located opposite to that of the extension 40 mentioned in the prior embodiment and has a size greater than that of the extension 40 of the movable member 4, the knob body 30a of the limit knob 3a has a side opening 301a in communication with the second opening 302a to allow passage of the extension 40a of the movable member 4a. Thus, when the movable member 4a is moved to the first position as shown in FIG. 11, the extension 40a of the movable member 4a blocks the second opening 302a, and when the movable member 4a is moved to the second position as shown in FIG. 12 by pushing of the movable shaft 51a of the first locking mechanism 5, the extension 40a of the movable member 4a is detached from the second opening 302a and urges the elastic member 31a. In addition, the extension 40a of the movable member 4a protrudes from the second opening 302a so as to protect the shackle.

Although the invention has been explained in relation to its embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A padlock comprising:
a housing;
a shackle movably mounted on the housing and including a root section disposed within the housing and a free section which extends from the root section and is disposed outside of the housing;
a limit knob movably mounted on the housing to control movement of the free section of the shackle;
a movable member movably disposed at the limit knob; and
a locking mechanism including a key lock unit disposed in the housing and a movable unit movably disposed in the housing; the key lock unit being configured to control movement of the limit knob and defining a key hole to receive a key; and the movable unit including a first portion engaged with the movable member and a second portion received in and aligned with the key hole of the key lock unit so that when the key is inserted into the key hole to actuate the movable unit, the movable member is driven by the movable unit to move from its original position to an indicative position which is at the limit knob.

2. The padlock of claim 1, wherein the second portion of the movable unit is received in the key hole of the key lock unit so that when the key or an insert is inserted into the key hole to a predetermined position, the second portion of the movable unit together with the first portion is pushed in a direction which in turn drives the movable member to the indicative position.

3. The padlock of claim 2, wherein the limit knob defines a recess to receive the free section of the shackle.

4. The padlock of claim 3, wherein the recess of the limit knob includes a first opening defined in a central portion of the limit knob and a second opening defined in a peripheral wall of the limit knob and being in communication with the first opening wherein the first opening enables the free section of the shackle to move in or out of the recess of the limit knob vertically and the second opening enables the free section to rotate in or out of the recess of the limit knob horizontally.

5. The padlock of claim 2, wherein the movable member is annular-shaped and the limit knob is formed with a shaft portion about which the movable member is movably mounted.

6. The padlock of claim 5, wherein the limit knob defines a recess to receive the free section of the shackle.

7. The padlock of claim 1, wherein the limit knob defines an opening to allow insertion of the free section of the shackle or an insert in such a way that the movable unit is able to be directly driven by the free section or the insert to move the movable member back to its original position.

8. The padlock of claim 1 further comprising a number lock module disposed in the housing to control upward and downward movement of the root section of the shackle.

9. The padlock of claim 8 wherein the movable member is allowed to move from the indicative position to its original position only if the number lock module is disposed at an unlocked state.

10. A lock comprising:
a housing defining an opening;
a movable member disposed in the housing;
a key lock unit disposed in the housing and defining a key hole to receive a key;
a movable unit disposed in the housing and including a first portion engaged with the movable member and a second portion received in and aligned with key hole of the key lock unit so that insertion of the key into key hole drives the movable unit to move the movable member to an indicative position which is outside of the housing, and insertion of an insert into the opening of the housing drives the movable member back to its original position.

11. The lock of claim 10, wherein the second portion of the movable unit is received in the key hole of the key lock unit so that when the key or an insert is inserted into the key hole to a predetermined position, the second portion of the movable unit together with the first portion is pushed in a direction which in turn drives the movable member to the indicative position.

12. The lock of claim 10, wherein the movable unit includes a third portion received in and aligned with the opening of the housing, and the insertion of the insert into the opening drives the third portion of the movable unit together with the first portion of the movable unit to move the movable member from the indicative position to its original position.

13. The lock of claim 10 further comprising a shackle movably mounted on the housing and a number lock module disposed in the housing; the number lock module being configured to control upward and downward movement of the shackle.

14. The lock of claim 10 further comprising a number lock module disposed in the housing, wherein the key lock unit and the number lock module are operable independent of each other.
